(19) United States
(12) Patent Application Publication
(10) Pub. No.: US 2006/0291532 A1
(43) Pub. Date: Dec. 28, 2006

(54) Method and apparatus for measurement of skin temperature

(75) Inventor: David A. Wyatt, San Jose, CA (US)

Correspondence Address: INTEL CORPORATION, P.O. BOX 5326, SANTA CLARA, CA, 95056-5326, US

(73) Assignee: Intel Corporation

(21) Appl. No.: 11/168,092

(22) Filed: Jun. 27, 2005

(51) Int. Cl. G01K 11/00

(52) U.S. Cl. 374/161

(57) ABSTRACT

In some embodiments, skin temperature of a computer system may be determined using a thermo-chromatic material, at least one light source and at least one sensor. Light from the light source is reflected from the thermo-chromatic material. The reflected light may be sensed by the sensor and used to determine the skin temperature. Other embodiments are described and claimed.

### FIELD OF THE INVENTION

The present invention relates generally to field of thermal management. More specifically, the present invention relates to methods and apparatus for determining temperature.

### BACKGROUND

Smaller and more powerful electronic components allow for the design and construction of higher performance computer systems, especially portable computer systems (e.g., laptop or notebook computers). A portable computer system may include a base unit and a display unit. The base unit may include an input device (e.g., a keyboard or a touchpad) and a number of electronic components (e.g., processor, disk drive, memory modules, etc.). The display unit may include a liquid crystal display (LCD) and associated electronic components. When in operation, each of these electronic components may generate a certain amount of heat. The heat may cause the skin temperature of the portable computer system to rise.

The skin temperature in portable computers and especially in computers designed to be usable on a person lap while sitting, is an extremely important platform design criteria. Excessive temperatures on the underskin of such a system can disturb, or even injure the user, resulting in customer support calls, and sometimes even in litigation. Even subtle temperature differentials for example between left and right hand palm rests on the upper surface of such systems can lead to customer concern and support call overhead. Typically portable computer systems manufacturers have specific expectations and limits for skin temperature.

One technique for measuring the skin temperature includes the use of one or more temperature sensors placed in contact with the skin material. This may require careful bonding of the temperature sensors to the surface of the material. This may also require connecting wires from the thermal sensors to a controller logic, increasing cost and assembly complexity. Another technique for measuring the skin temperature includes infra-red (IR) absorption. However this technique has the disadvantages of requiring expensive IR emitter and high-sensitivity IR photo-diodes, and which is easily disrupted by contaminants, or other material collecting on the face of the emitter or sensor.

### BRIEF DESCRIPTION OF THE DRAWINGS

The present invention is illustrated by way of example, and not limitation, in the figures of the accompanying drawings in which like references indicate similar elements and in which:

FIG. 1A is a block diagram illustrating an example of a computer system that may be used, in accordance with an embodiment of the invention.

FIG. 1B illustrates a side view example of a base unit of a portable computer system, in accordance with one embodiment.

FIG. 2 illustrates an example of a configuration that may be used to measure the skin temperature of a computer system, in accordance with one embodiment.

FIG. 3 illustrates an example of a base unit of a computer system, in accordance with one embodiment.

FIG. 4 is a block diagram illustrating an example of a controller that may be used to determine the skin temperature, in accordance with one embodiment.

FIG. 5 is a flow diagram illustrating an example of a process used to determine temperature using a thermo-chromatic material, in accordance with one embodiment.

### DETAILED DESCRIPTION

For some embodiments, methods to measure skin temperature of a computer system are disclosed. Using a thermo-chromatic material attached to the skin of the computer system, the skin temperature may be determined.

In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

Computer System

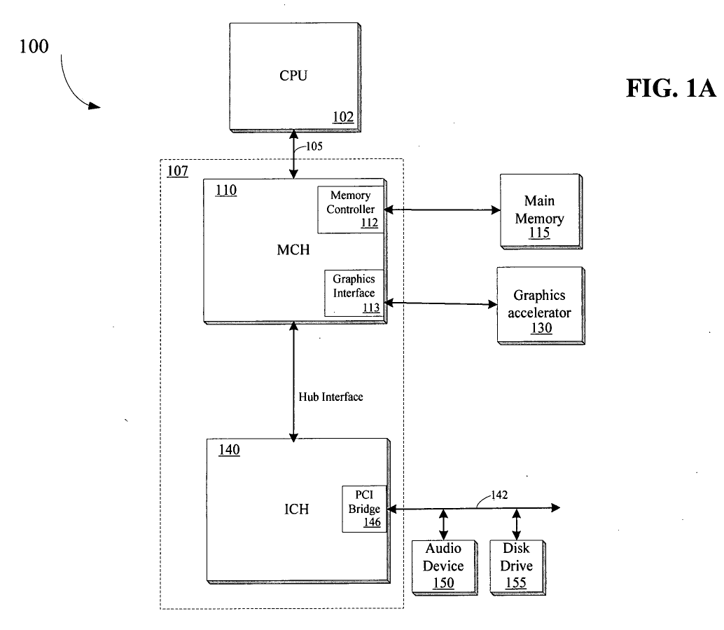

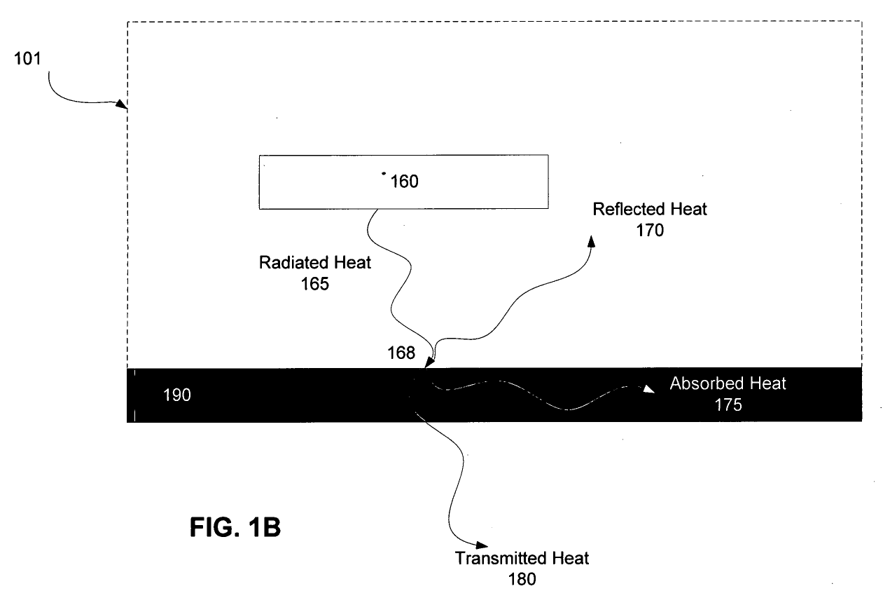

FIG. 1A is a block diagram illustrating an example of a computer system that may be used, in accordance with an embodiment of the invention. Computer system 100 may include a central processing unit (CPU) 102 and may receive its power from an electrical outlet or a battery. The CPU 102 and chipset 107 may be coupled to bus 105. The chipset 107 may include a memory control hub (MCH) 110. The MCH 110 may include a memory controller 112 that is coupled to system memory 115. The system memory 115 may store data and sequences of instructions that are executed by the CPU 102 or any other processing devices included in the computer system 100. The MCH 110 may include a graphics interface 113. Display 130 may be coupled to the graphics interface 113. The chipset 107 may also include an input/output control hub (ICH) 140. The ICH 140 is coupled with the MCH 110 via a hub interface. The ICH 140 provides an interface to input/output (I/O) devices within the computer system 100. The ICH 140 may include PCI bridge 146 that provides an interface to PCI bus 142. The PCI bridge 146 may provide a data path between the CPU 102 and peripheral devices. An audio device 150 and a disk drive 155 may be connected to the PCI bus 142. The disk drive 155 may include a storage media to store data and sequences of instructions that are executed by the CPU 102 or any other processing devices included in the computer system 100. Although not shown, other devices (e.g., keyboard, mouse, etc.) may also be connected to the PCI bus 142. When the computer system 100 is in operation, each of the components mentioned above may generate heat.

Skin Temperature

FIG. 1B illustrates a side view example of a base unit of a portable computer system, in accordance with one embodiment. For one embodiment, the skin temperature may include the temperature of the external surface of the portable computer system. This may include the temperature of the skin associated with the base unit 101 of the portable computer system. Electronic component 160 (e.g., processor, chipset, etc.) inside the base unit 101 may generate heat (referred to as radiated heat 165) when it is in operation. The radiated heat 165 may radiate toward point 168 on the internal surface of the skin 190 of the base unit 101. Some percentage of the radiated heat 165 may be reflected (referred to as reflected heat 170) and may stay within the base unit 101. Some percentage of the radiated heat 165 may be transmitted (referred to as transmitted heat 180) and dispersed into the ambient air. Some percentage of the radiated heat 165 may be absorbed (referred to as absorbed heat 175) into the skin 190.

The absorbed heat 175 may cause the skin temperature of the skin 190 to rise. Keeping the skin temperature cool may be necessary especially when the base unit 101 is placed on an irregular surface or a surface that has poor airflow. Keeping the skin temperature cool may also be necessary for user's comfort when the base unit 101 in placed on the user's lap. Typically, cooling the skin temperature may be performed using active cooling (e.g., fans) or passive cooling (e.g., power/performance throttles). For example, when the temperature sensor senses that the skin temperature has reached a first temperature threshold, a fan may be configured by controller logic to operate at a first speed. When the temperature sensor senses that the skin temperature has reached a second temperature threshold, the fan may be configured by the controller logic to operate at a faster second speed.

Thermo-Chromatic Material

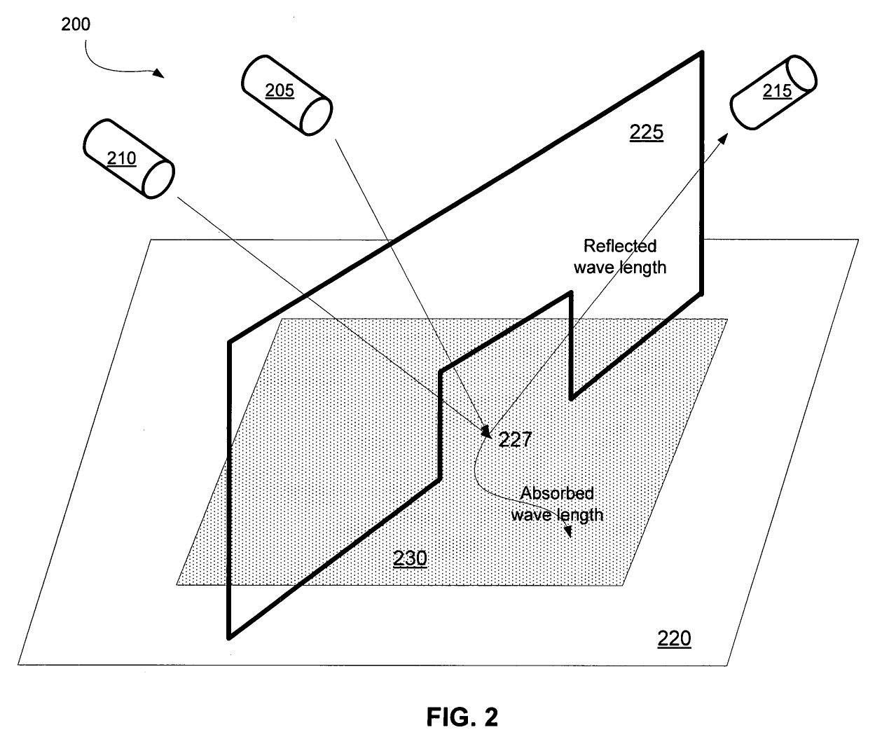

FIG. 2 illustrates an example of a configuration that may be used to measure the skin temperature of a computer system, in accordance with one embodiment. The configuration 200 may include a thermo-chromatic material 230, or a material that changes color when its temperature changes. The thermo-chromatic material 230 may be attached to surface 220. For example, the thermo-chromatic material 230 may include an adhesive backing. The surface 220 may be an internal surface of the skin of a computer system. When the surface 220 and the thermo-chromatic material 230 become hot (e.g., due to the heat generated by the electronic components), the color of the thermo-chromatic material 230 may change. Each color is associated with a different wavelength measured in nanometers (nm). For example, the wavelength for the color red (680 nm) is different from the wavelength for the color yellow (550 nm) or violet (410 nm).

The color of the thermo-chromatic material 230 changes based on the wavelength of the colors that the thermo-chromatic material 230 absorbs. The wavelength of the color that is less absorbed is usually the color of the thermo-chromatic material 230. For example, when the temperature of the surface 220 reaches a first level, the color of the thermo-chromatic material 230 may be violet. The color may change to blue, cyan, green, yellow, orange or red when the temperature reaches a different level. Thus, when the color of the thermo-chromatic material 230 is red, it may be that the wavelengths of the colors violet, blue, cyan, green, yellow and orange have been absorbed by the thermo-chromatic material 230.

Light Source

For one embodiment, the configuration 200 may also include one or more light sources. In the current example, there are two light sources 205, 210. The light sources 205, 210 may be configured to direct light at the thermo-chromatic material 230. The light from the light sources 205, 210 may be within a known spectrum (or spectral distribution), and may include visible light which is a range of wavelengths within the electromagnetic spectrum that the eyes respond to. This visible light spectrum may include the color violet with the shortest wavelength and the color red with the longest wavelength.

For one embodiment, the wavelengths of the color that are absorbed by the thermo-chromatic material 230 may be similar to some of the wavelengths of the color of the light from the light sources 205, 210. As a result, some of the wavelengths of the color of the light may also be absorbed by the thermo-chromatic material 230. The wavelength of the color of the light that is not absorbed by the thermo-chromatic material 230 may be reflected. When the temperature of the surface 220 and of the thermo-chromatic material 230 change, a different wavelength of the color of the light may be reflected from the thermo-chromatic material 230.

Sensor

For one embodiment, the configuration 200 may include a sensor 215. The sensor 215 may be an optical photo sensor (e.g., Cadmium Sulphide sensor). The sensor 215 may be configured to sense the wavelength of the color of the light that is reflected from the thermo-chromatic material 230. For one embodiment, the configuration 200 may also include an opaque light baffle 225. The baffle 225 may be positioned in between the light sources 205, 210 and the sensor 215 to prevent the light from the light sources 205, 210 to pass through to the sensor 215. This may reduce the possibility that the sensor 215 senses the wavelengths of the colors of the light before they are absorbed by the thermo-chromatic material 230. The baffle 225 may also be positioned to not interfere with the wavelength of the color of the light that is reflected from the thermo-chromatic material 230. As illustrated in FIG. 2, the baffle 225 may include an opening to enable the appropriate wavelength to reflect as well as to prevent the sensor 215 to sense the incorrect wavelengths.

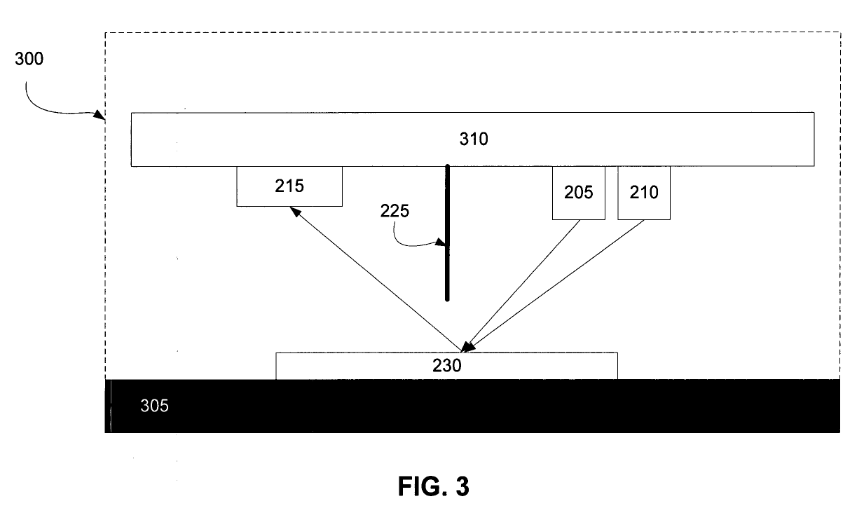

FIG. 3 illustrates an example of a base unit of a computer system, in accordance with one embodiment. The base unit 300 includes a system board 310 which may include multiple electronic components (not shown) capable of generating heat. The base unit 310 also includes the light sources 205, 210, the sensor 215 and the baffle 225. Light from the light sources are configured to direct light at the thermo-chromatic material 230 coupled to the internal surface of the skin 305. Light reflected from the thermo-chromatic material 230 is sensed by the sensor 215. For one embodiment, the temperature of the internal surface of the skin 305 may be used to infer the temperature of the external surface of the skin 305.

Controller

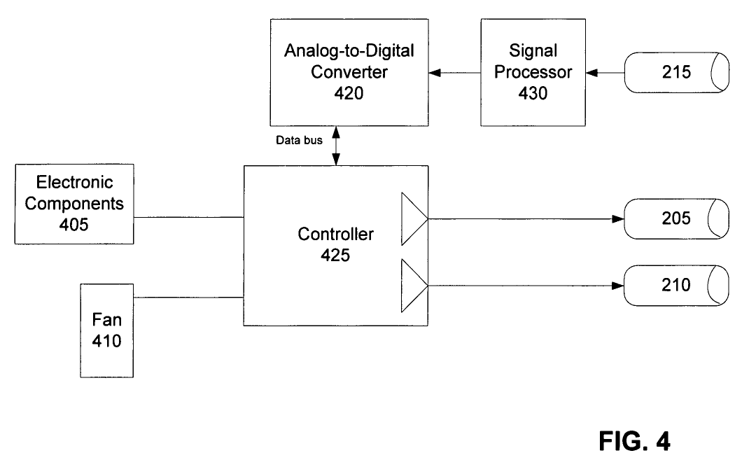

FIG. 4 is a block diagram illustrating an example of a controller that may be used to determine the skin temperature, in accordance with one embodiment. For one embodiment, controller 425 may be an embedded controller within the computer system 100. The controller 425 may be coupled to an analog to digital (ATD) converter 420 via a data bus. The ATD converter 420 is coupled to a signal processor 430 which receives information from the sensor 215. The controller 425 is coupled to the light sources 205, 210 and may control the light sources 205, 210 using general purpose input/output drivers (not shown). Although not shown, the controller 425 may also be coupled to the processor 102 and the chipset 107 (illustrated in FIG. 1A). The controller 425 may also be able to execute thermal management instructions to control the operations of the electronic components 405 and/or the fan 410. It may be noted that the processor 102 may also perform some or all of the operations of the controller 425.

Determining Temperature

The light from the light sources 205, 210 supplies the spectral energy required for viewing the colors. For one embodiment, the spectral energy of the light source 205 may be in a region that is highly absorbed by the thermo-chromatic material 230, and the spectral energy of the light source 210 may be in a region that is less absorbed by the thermo-chromatic material 230. In this example, the temperature of the thermo-chromatic material 230 may be determined by measuring the amount of light reflected from the light source 205 and comparing that against the amount of light reflected from the light source 210.

For one embodiment, a ratio of the reflected light from the light sources 205, 210 (as sensed by the sensor 215) may be used as a temperature dependent spectral absorption of the thermo-chromatic material 230. The ratio may be used to derive the temperature using predetermined information. For example, the predetermined information may be stored in a form of a look-up table. Alternatively, the ratio may be used in a formula to determine the temperature. Other information that may be taken into consideration when determining the temperature includes the characteristic of a particular thermo-chromatic material and of the light sources as used in an enclosure (e.g., base unit) of a computer system, as well as the transmissibility, reflectivity, and absorption of the skin of the computer system.

Other operations may be performed in deriving the temperature including, for example, computing an average, differential and/or integral, etc. The temperature may then be compared with pre-determined thresholds. When said thresholds are exceeded, appropriate thermal management operations may be performed. This may include, for example, causing an event to notify thermal management software to perform throttling operations of the electronic components. This may also include, for example, causing an electronic component to self-throttle or to shut down, causing a fan to start or to increase speed, etc.

Variations in the wavelength of the color of the light reflected from the thermo-chromatic material 230 or in the wavelengths of the color of the light absorbed by the thermo-chromatic material 230 due to environmental factors (e.g., variations in reflectivity and emissivity) may be rejected. The ambient light may also be considered because it may be sensed by the sensor 215. For example, when the temperature of the thermo-chromatic material 230 increases, and the color of the thermo-chromatic material 230 changes from the color green to the color red, it may mean that more of the amount of the colors blue and yellow are absorbed by the thermo-chromatic material 230. It may also mean that when the temperature of the thermo-chromatic material 230 decreases, less of the colors blue and yellow are absorbed as compared to the color red (which may be more likely to be absorbed).

Different combinations of light sources and sensor may be used to detect the change in the reflected light wavelengths. For one embodiment, the light sources may have a different spectral energy, and the sensor may be a broad spectrum sensor. For example, the light source 205 may emit light having different wavelengths from the light source 210, while the sensor 215 may be able to sense light from both of the light sources 205, 210. For one embodiment, each of the light sources may have narrow spectral energy, and the sensor may be a broad spectrum sensor. When light of a narrow spectrum is bounced off the thermo-chromatic material, more light in specific wavelengths may be absorbed, or reflected, depending on the thermo-chromatic shift and the temperature of the thermo-chromatic material 230. For example, the light source 205 may be a yellow light emitting diode (LED), and the light source 210 may be a red LED. For another embodiment, each of the light sources may have broad spectral energy, and the sensor may be a narrow spectrum sensor. For yet another embodiment, there may be one light source with broad spectral energy and two narrow spectrum sensors. It may be noted that, depending on the implementation, the techniques described above may be implemented using different number of light sources and sensors. However when sensing reflected intensity using two different spectrums and measuring the difference between them, the effects of surface/sensor/emitter contamination can effectively be eliminated, providing an advantage over other remote temperature sensing techniques such as IR absorption.

It may be noted that embodiments of the invention described herein may be implemented as a non-contact solution for measuring skin temperatures. In some embodiments, the solution may be advantageous over other solutions because a low cost LED and sensor may be used.

Process

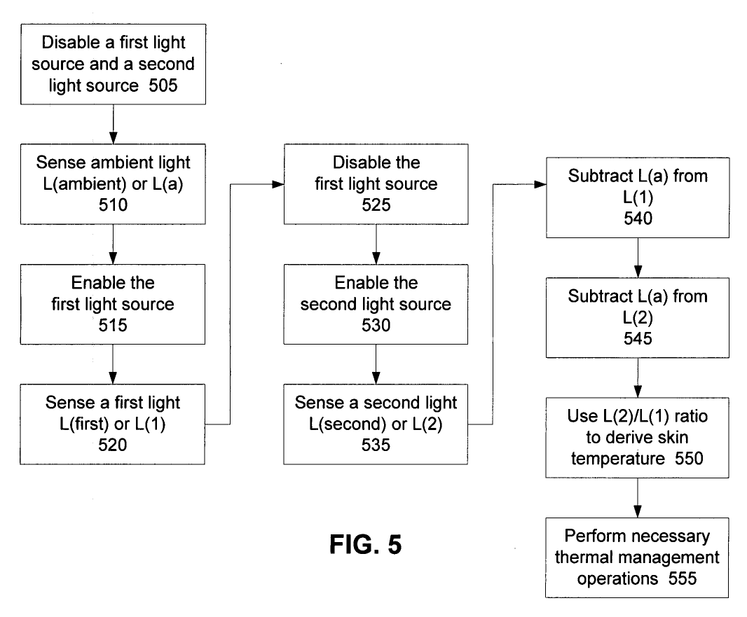

FIG. 5 is a flow diagram illustrating an example of a process used to determine temperature using a thermo-chromatic material, in accordance with one embodiment. In this example, the process includes the use of two light sources and one sensor such as the configuration illustrated in FIG. 2. Since the ambient light may affect how the sensor senses the wavelength of the color of the light reflected from the thermo-chromatic material, it may be useful to obtain a baseline by first disabling the light sources, as shown in block 505. Ambient light (referred to as L(a)) is then sensed by the sensor while the light sources remain disabled, as shown in block 510.

After the ambient light is sensed, the light from the first and second light sources are sensed. At block 515, the first light source is enabled while the second light source remains disabled. At block 520, light from the first light source that is reflected from the thermo-chromatic material (referred to as L(1)) is sensed by the sensor. At block 525, the first light source is disabled. At block 530, the second light source is enabled. At block 535, light from the second light source that is reflected from the thermo-chromatic material (referred to as L(2)) is sensed by the sensor.

After the light from the first and second light sources are sensed, the effect of the ambient light is removed. At block 545, the reflected light L(1) from the first light source that is sensed by the sensor is adjusted by removing the sensed ambient light L(a). At block 550, the reflected light L(2) from the second light source that is sensed by the sensor is adjusted by removing the sensed ambient light L(a).

At block 555, a ratio of the adjusted L(1) over the adjusted L(2) (or L(1)/L(2)) is determined and is used to determine the skin temperature. At block 560, a controller may use the skin temperature to determine the appropriate thermal management operations to perform. This may include passive and/or active thermal management operations.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A system, comprising:
a surface;
a thermo-chromatic material coupled to the surface;
at least one light source to direct light of known spectral distribution at the thermo-chromatic material;
at least one sensor to sense the light reflected from the thermo-chromatic material; and
a controller to determine temperature of the surface using knowledge of the spectral distribution of the light source and information provided by the sensor.

2. The system of claim 1, further comprising:
a light baffle coupled to the thermo-chromatic material and positioned in between the light source and the sensor.

3. The system of claim 1, wherein the surface is an internal surface of a skin.

4. The system of claim 3, wherein the light source is a narrow spectrum light source.

5. The system of claim 4, wherein the sensor is a wide spectrum sensor.

6. The system of claim 3, wherein the light source is a wide spectrum light source.

7. The system of claim 6, wherein the sensor is a narrow spectrum sensor.

8. The system of claim 1, wherein the light reflected from the thermo-chromatic material includes a light having a wavelength color different from wavelengths of colors absorbed by the thermo-chromatic material.

9. The system of claim 8, wherein the information provided by the sensor includes information associated with the light reflected from the thermo-chromatic material.

10. The system of claim 9, wherein the information provided by the sensor includes information associated with ambient light.

11. The system of claim 1, wherein the controller is to further determine thermal management operations based on the determined temperature of the surface.

12. A method, comprising:
generating light from at least one light source, the light directed at a thermo-chromatic material;
sensing reflected light from the thermo-chromatic material using at least one sensor; and
determining temperature of a surface coupled to the thermo-chromatic material using information associated with the reflected light.

13. The method of claim 12, further comprising:
sensing ambient light using the at least one sensor while the at least one light source is disabled, wherein the temperature is further determined using information associated with the ambient light.

14. The method of claim 13, wherein sensing the reflected light comprises sensing a wavelength of a color of the reflected light.

15. The method of claim 14, wherein the wavelength of the color of the reflected light is not absorbed by the thermo-chromatic material.

16. The method of claim 15, wherein the at least one light source is a narrow spectrum light source and the at least one sensor is a wide spectrum sensor.

17. The method of claim 15, wherein the at least one light source is a wide spectrum light source and the at least one sensor is a narrow spectrum sensor

18. The method of claim 12, wherein the at least one light source includes a first light source and a second light source, and wherein the reflected light includes a first reflected light from the first light source and a second reflected light from the second light source.

19. The method of claim 18, wherein sensing the reflected light comprises sensing a first wavelength associated with the first reflected light and sensing a second wavelength associated with the second reflected light.

20. The method of claim 19, wherein determining the temperature comprises comparing the first wavelength with the second wavelength.

21. The method of claim 20, further comprising performing cooling operations when the determined temperature reaches a threshold.

22. A system, comprising:
means for generating light onto a thermo-chromatic material;
means for sensing reflected light from the thermo-chromatic material; and
means for analyzing the reflected light to determine temperature of the thermo-chromatic material.

23. The system of claim 22, further comprising means for separating the means for generating light and the means for sensing the reflected light.

24. The system of claim 23, further comprising means for removing factors that affect the reflected light.

25. The system of claim 24, wherein the factors include ambient light and reflectivity of the thermo-chromatic material.

26. The system of claim 24, wherein the thermo-chromatic material is coupled to a skin of a computer system, and wherein temperature of the skin is related to the temperature of the thermo-chromatic material.

27. The system of claim 26, further comprising means for using the determined temperature to control means for cooling the temperature of the skin.
